(19) United States
(12) Patent Application Publication
(10) Pub. No.: US 2012/0085434 A1
(43) Pub. Date: Apr. 12, 2012

(54) METHOD AND APPARATUS FOR FLOW DEVICE

(76) Inventor: William Powanda, Franklin Park, NJ (US)

(21) Appl. No.: 12/901,601

(22) Filed: Oct. 11, 2010

(51) Int. Cl. F16K 15/00

(52) U.S. Cl. 137/455

(57) ABSTRACT

An apparatus and method for controlling the flow of fluids such as liquids or gasses. The apparatus may include an input control valve, an input manifold, first, second, and third further control valves, first, second, and third flow meters, first, second, and third check valves, and an output manifold. The apparatus may further include a control central processing unit which controls the input control valve, the first, second, and third further control valves, and the output control valve. The control central processing unit may receive one or more signals concerning fluid flow through the first, second, and third flow meters and may control flow through the meters by controlling one or more valves. Each of the first, second, and third flow meters may be a coriolis flow meter.

### FIELD OF THE INVENTION

This invention relates to improved methods and apparatus concerning flow control, metering and calibration devices.

### BACKGROUND OF THE INVENTION

Flow pressure and temperature devices for measuring the flow and temperature of gasses and liquids are known. However, existing pressure and temperature measuring devices are not sufficiently accurate, reliable, and are difficult to operate.

### SUMMARY OF THE INVENTION

At least one embodiment of the present invention provides an apparatus for controlling the flow of fluids such as liquids or gasses. The apparatus may include an input control valve having an input port for receiving a fluid and an output port, an input manifold having an input port and first and second output ports, the input port of the input manifold connected to the output port of the input control valve. The apparatus may also include a first further control valve having an input port and an output port, the input port of the first further control valve connected to the first output port of the input manifold, and a second further control valve having an input port and an output port, the input port of the second further control valve connected to the second output port of the input manifold. The apparatus may also include a first flow meter having an input port and an output port, the input port of the first flow meter connected to the output port of the second further control valve, and a second flow meter having an input port and an output port, the input port of the first flow meter connected to the output port of the second further control valve.

The apparatus may further include a first check valve having an input port and an output port, the input port of the first check valve connected to the output port of the first flow meter, a second check valve having an input port and an output port, the input port of the second check valve connected to the output port of the second flow meter. The apparatus may also include an output manifold having first and second input ports and an output port, the first input port of the output manifold connected to the output port of the first flow meter, the second input port of the output manifold connected to the output port of the second flow meter, and an output control valve having an input port and an output port, the input port of the output control valve connected to the output port of the output manifold.

The apparatus may further include a control central processing unit which controls the input control valve, the first further control valve, the second further control valve, the output control valve. The control central processing unit may be configured to be in communication with the first flow meter and the second flow meter, such that the control central processing unit receives one or more signals concerning fluid flow through the first flow meter and the second flow meter.

The input manifold may have a third output port, and the apparatus may be further comprised of a third further control valve having an input port and an output port, the input port of the third further control valve connected to the third output port of the input manifold. The apparatus may be further comprised of a third flow meter having an input port and an output port, the input port of the third flow meter connected to the output port of the third further control valve. The apparatus may also include a third check valve having an input port and an output port, the input port of the third check valve connected to the output port of the third flow meter, wherein the output manifold has a third input port, the third input port of the output manifold connected to the output port of the third flow meter. The control central processing unit may control the third further control valve, and the control central processing unit may be configured to be in communication with the third flow meter, such that the control central processing unit receives one or more signals concerning fluid flow through the third flow meter.

Each of the first, second, and third flow meters may be a coriolis flow meter. The apparatus may be further comprised of a computer display, a computer interactive device, a computer memory, and a computer processor. The computer memory may have stored therein a computer program which is executed by the computer processor in communication with the control central processing unit to cause information about the flow of fluid through the first flow meter and the second flow meter to be displayed on the computer display.

The computer memory may also have stored therein a computer program which is executed by the computer processor in communication with the control central processing unit to receive commands from an operator via the computer interactive device to control the input control valve, the first further control valve, the second further control valve, and the output control valve.

The apparatus further include a sealed and waterproof enclosure, wherein the input control valve, the input manifold, the first further control valve, the second further control valve, the first flow meter, the second flow meter, the first check valve, the second check valve, the output manifold, and the output control valve are located within the sealed and waterproof enclosure. The apparatus may be portable.

The computer memory may have stored therein a computer program which is executed by the computer processor in communication with the control central processing unit to automatically control the input control valve, the first further control valve, the second further control valve, and the output control valve. The computer memory may have stored therein a computer program which is executed by the computer processor in communication with the control central processing unit to automatically control the input control valve, the first further control valve, the second further control valve, the third further control valve, and the output control valve.

The computer program may automatically control the input control valve, the first further control valve, the second further control valve, and the output control valve based on information received by the computer processor from the first flow meter, the second flow meter, and/or the third flow meter.

The first flow meter, the second flow meter, and the third flow meter may be fixed and mounted to a support plate, and may be mounted and fixed so that the first flow meter is substantially parallel to the second and the third flow meters.

The computer processor and/or computer memory may include a computer program that runs a self diagnostic program which automatically controls the input control valve, the first further control valve, the second further control valve, and the output control valve, and which examines one or more readings from the first flow meter and the second flow meter responsive to the automatic control of the input control valve, the first further control valve, the second further control valve, and the output control valve, to determine if the apparatus is operating properly and which displays information on the computer display to indicate if the apparatus is operating properly.

At least one embodiment of the present invention includes a method of controlling flow of a fluid such as a liquid or gas comprising passing the fluid through a first flow meter to determine a first flow rate, determining if the first flow rate is within a specified range of a first desired flow rate; and using a computer processor to close a first valve so that the fluid is no longer passed through the first flow meter if the first flow rate is not within the specified range of the first desired flow rate; and using the computer processor to open a second valve so that the fluid can flow through a second flow meter.

In yet another embodiment of the present invention, a method is provided including sending a first signal to a computer processor to indicate a first current flow rate of a first fluid through a first flow meter, changing the first current flow rate of the first fluid through the first flow meter to a first new flow rate of the first fluid through the first flow meter by using the computer processor to control a first valve in response to the first signal, sending a second signal to the computer processor to indicate a second current flow rate of a second fluid through a second flow meter, and changing the second current flow rate of the second fluid through the second flow meter to a second new flow rate of the second fluid through the second flow meter by using the computer processor to control a second valve in response to the second signal.

The method may also include sending a third signal to the computer processor to indicate a third current flow rate of a third fluid through a third flow meter, and changing the third current flow rate of the third fluid through the third flow meter to a third new flow rate of the third fluid through the third flow meter by using the computer processor to control a third valve in response to the third signal.

The method may further include measuring a first temperature of the first fluid while it is flowing through the first flow meter at the first current flow rate, wherein the first new flow rate is set by the computer processor based on the first temperature, and/or measuring a second temperature of the second fluid while it is flowing through the second flow meter at the second current flow rate, wherein the second new flow rate is set by the computer processor based on the second temperature. The method may further include measuring pressure at the inlet before the first main control valve and may include measuring pressure at the outlet beyond the outlet of the outlet manifold.

One or more embodiments of the present invention provide a more accurate and more reliable flow pressure and temperature device, such as for routine calibration work while servicing a customer. At least one embodiment of the present invention uses standard coriolis technology. At least one or more embodiments of the present invention are more reliably accurate and easier to operate than existing products on the market at this present time.

In one or more embodiments an apparatus is provided which can measure flow, temperature, and pressure more effectively than previously done before. This is accomplished by utilizing advanced measuring technologies and using advanced operator friendly computer software all combined together to allow an operator to virtually control and measure all operations. In at least one embodiment, the apparatus may incorporate standard measuring technologies, but enhance accuracy, flow control and calibrating parameters.

### BRIEF DESCRIPTION OF THE DRAWINGS

FIG. 1 shows a front top right perspective view of an apparatus in accordance with an embodiment of the present invention;

FIG. 2 shows a rear top left perspective view of the apparatus of FIG. 1;

FIG. 3 shows a top view of the apparatus of FIG. 1;

FIG. 4 shows a front view of the apparatus of FIG. 1;

FIG. 5 shows a block diagram of communications between various components of the apparatus of FIG. 1;

FIG. 6 shows a block diagram of communications between a control central processing unit of the apparatus of FIG. 1 and a computer;

FIG. 7 shows a first image which may be displayed on a computer display of the computer of FIG. 6 in accordance with another embodiment of the present invention;

FIG. 8 shows a second image which may displayed on a computer display of the computer of FIG. 6 in accordance with another embodiment of the present invention;

FIG. 9 shows a third image which may displayed on a computer display of the computer of FIG. 6 in accordance with another embodiment of the present invention;

FIG. 10 shows a fourth image which may be displayed on a computer display of the computer of FIG. 6 in accordance with another embodiment of the present invention; and

FIG. 11 shows a fifth image which may be displayed on a computer display of the computer of FIG. 6 in accordance with another embodiment of the present invention.

### DETAILED DESCRIPTION OF THE DRAWINGS

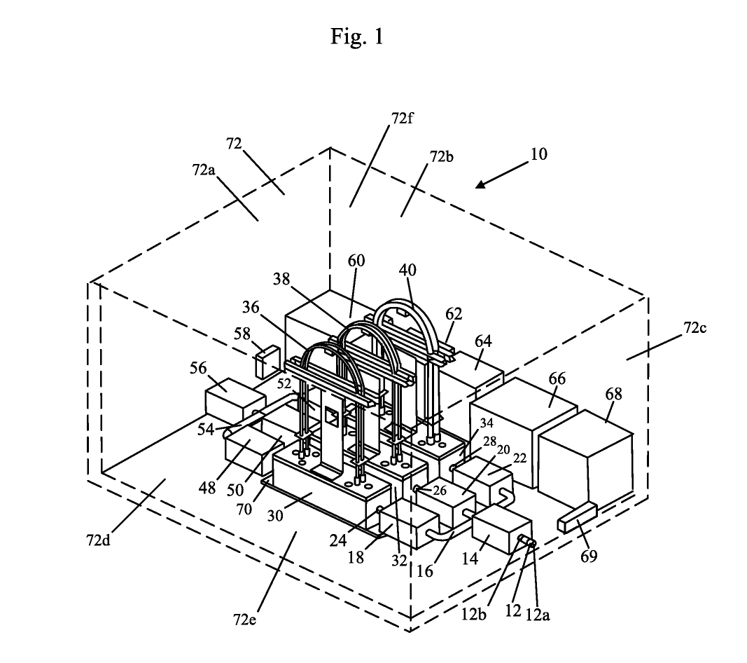

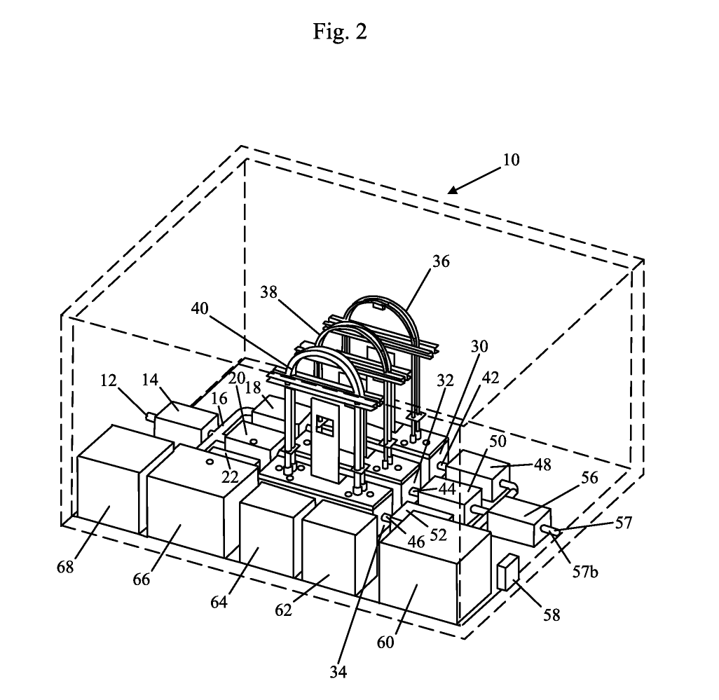

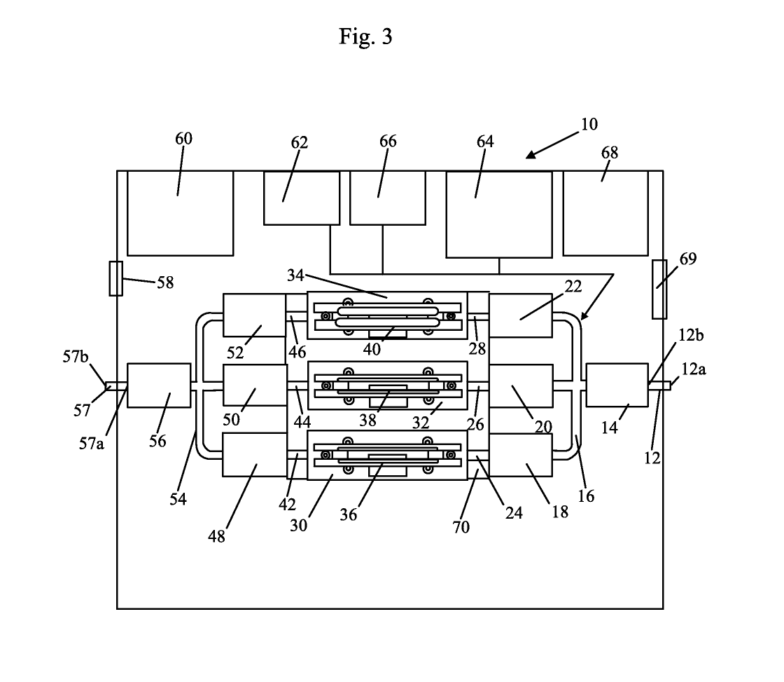

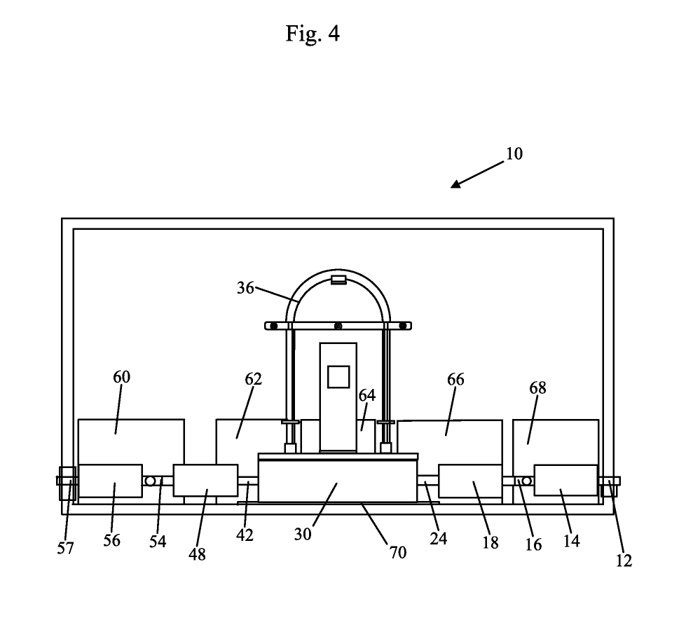

FIG. 1 shows a front top right perspective view of an apparatus 10 in accordance with an embodiment of the present invention. FIG. 2 shows a rear top left perspective view of the apparatus 10. FIG. 3 shows a top view of the apparatus 10. FIG. 4 shows a front view of the apparatus 10 of FIG. 1.

Referring to FIG. 1, the apparatus 10 includes an input pipe or tube 12 having an input port or opening 12a into which gas or fluid can flow, and an output port or opening 12b which is connected to an input port or opening of a control valve 14. The control valve 14 has an output port or opening which is connected an input of a manifold 16. The manifold 16 has one branch at its input and three branches at its output, with each output branch connected to a separate input of control valves 18, 20, and 22, respectively. The control valves 18, 20, and 22 are connected at their outputs to inputs of pipes 24, 26, and 28, respectively. The pipes 24, 26, and 28 are connected at their outputs to inputs of meters 36, 38, and 40. The metering tubes 36, 38, and 40 are supported by, and typically mounted and fixed on, support blocks 30, 32, and 34, respectively. The metering tubes 36, 38, and 40 may be fixed and mounted to support blocks 30, 32, and 34, and to mount or plate 70, so that meters or tubes 36, 38, and 40 are substantially parallel to one another, which is beneficial for construction, to provide a more compact unit for portable operation by an operator.

The support blocks 30, 32, and 34 sit on and are mounted to the support plate or mount 70. The meter tubes 36, 38, and 40 are connected at their outputs to inputs of pipes 42, 44, and 46 respectively. The outputs of pipes 42, 44, and 46 are connected to inputs of check valves 48, 50, and 52 respectively. The outputs of check valves 48, 50, and 52 are connected to manifold device 54. The output of pipe device 54 is connected to an input of control valve 56. An output of control valve 56 is connected to input 57a of output pipe 57. The pipe has an output 57b.

The apparatus 10 includes a housing or enclosure 72 substantially in the form of a closed rectangular box, which is shown in dashed lines in FIG. 1. The housing 72 includes walls 72a, 72b, 72c, 72d, bottom 72e and top 72f which form a NEMA (National Electrical Manufacturer's Association) 4x, waterproof and sealed enclosure. The housing 72 can be made of a synthetic resin plastic for lightweight construction and solid durability.

The apparatus 10 may include an alternating current (AC) power connector 58 and a communications port 69. The apparatus 10 also includes a Direct Current (DC) power supply 60 twenty-four volts DC output, an RTD (Resistance Temperature Device) sensor 62, a pressure sensor 64, a power supply 66 five volts DC output, and a control central processing unit 68.

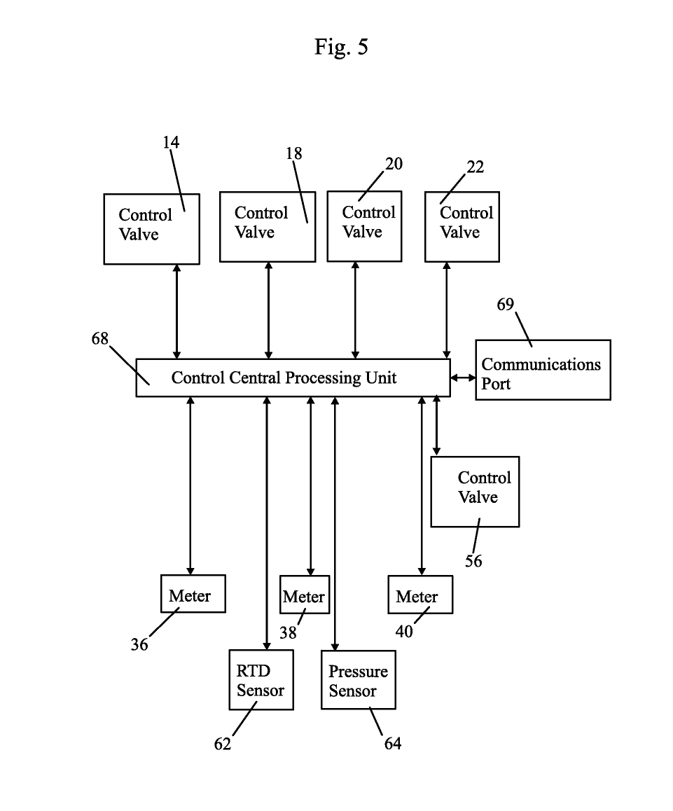

FIG. 5 shows a block diagram of communications between various components of the apparatus 10 of FIG. 1. As shown in FIG. 5, the control central processing unit 68 communicates with control valves 14, 18, 20, 22, and 56, with communications port 69, with meters 36, 38, and 40, and with sensors 62 and 64. The control central processing unit 68 may be electronically connected to the components 14, 18, 20, 22, 60, 56, 36, 38, 40, 62, and 64, such as by being connected by electrical conductors, or by being connected optically, wirelessly, or in other known manners. The control central processing unit 68 may include computer memory and a computer processor.

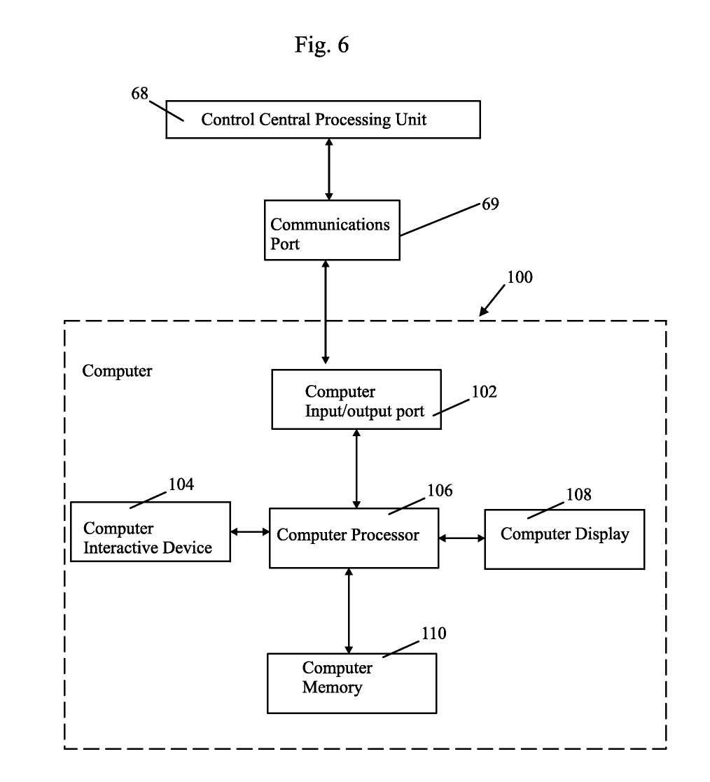

FIG. 6 shows a block diagram of communications between a control central processing unit 68 of the apparatus 10 of FIG. 1 and a computer 100. The computer 100 includes a computer input/output port 102, a computer interactive device 104, a computer processor 106, a computer display 108, and a computer memory 110. The computer interactive device 104 may include a computer mouse, a computer keyboard, a touch screen, or any other known computer interactive device. The control central processing unit 68 may communicate with the computer 100 via the communications port 69 and a communications link between the communications port 69 and the computer input/output port 102. The communications port 69 may communicate with the port 102 in a hardwired manner, wirelessly, optically, over the internet, or in any other known manner.

In operation referring to FIGS. 1-4, a flow material, such as a liquid or gas flows into input port or opening 12a of input pipe 12. The flow material, flows throw the pipe 12 and out opening 12b into an input or input port of control valve 14. If the control valve 14 is in an open state, the flow material flows through the control valve 14 and out an output or output port of control valve 14 into the input single branch of the manifold 16. The control central processing unit 68 may send a signal or signals to the control valve 14 to set the control valve 14 to an opened state.

The control central processing unit 68 also controls whether the control valves 18, 20, and 22 are in an opened state or in a closed state by sending appropriate signals to the control valves 18, 20, and 22. If only one of the control valves 18, 20, and 22 are in an open state, then the flow material flows from the pipe device 16 to an input port of the particular open control valve (of 18, 20, and 22), through the particular open control valve (of 18, 20, and 22), and out an output port of the particular open control valve (of 18, 20, and 22). If only one of the control valves 18, 20, and 22 are in an open state, then the flow material next flows from an output port of the particular open control valve (of 18, 20, and 22) into and through the appropriate pipe (of pipes 24, 26, and 28), then into and through the appropriate meters 36, 38, and 40, then into an through the appropriate pipe (of pipes 42, 44, and 46), then into and through the appropriate check valve (of check valves 48, 50, and 52), then into and through pipe device 54, then into and through control valve 56 (assuming control valve 56 is in an open state), and into and through pipe 57. The flow material exits at output port 57b.

The control valve 56 can be controlled by the control central processing unit 68 to put the control valve 56 in a closed state to prevent any flow material from coming through the control valve 56. The control valve 56 can be controlled by the control central processing unit 68 to put the control valve 56 in a opened state to allow flow material to come through the control valve 56. The control central processing unit 68 may send a signal or signals to the control valve 56 to put the control valve 56 in an opened or closed state.

The control central processing unit 68 may receive signals from the meters 36, 38, and 40 to control valves and flow paths and actual flow reading of fluid in tubes.

If more than one of the control valves 18, 20, and 22 are in an open or opened state, then the fluid in the manifold 16 will allow flow based on actual flow rate to a specific meter 36 38 40. The apparatus 10 is typically a portable unit enclosed in a NEMA 4x housing 72. The apparatus 10 can be used with many different types of fluids or gasses, such as for example (water, oils, fuels, alcohol, air, oxygen, hydrogen etc.) The apparatus 10 can be used to calibrate in a variety of engineering units such as (gallons per minute, liters per hour, standard cubic feet per hour, normal Liters per hour etc.)

The apparatus 10, in at least one embodiment, includes three different sized coriolis tubes or meters 36, 38, 40 shown in FIG. 1. The three coriolis tubes are internally mounted together via support blocks 30, 32, and 34 shown in FIG. 1 and manifolded together for a very large flow range turndown, such as a two thousand (2,000) to one (1) flow range turndown from the additional flow by flowing two to three streams simultaneously.

An example of multi-flow paths is high flow metering tube 40 can flow with medium flow tube 38 added to achieve a higher capacity flow rate. The operation is controlled from the control central processing unit 68 sending signals to inlet control valves 18, 20, and 22 shown in FIG. 1 to open and adjust for desired flow rate.

The control valves 14, 18, 20, 22, and 56 have positive shutoff and can be shutoff or placed in a closed or partially closed state by control central processing unit 68. Each flow stream of flow material (or a portion of flow material) will be controlled by a voltage signal such as 0-5 Volts/4-20 MilliAmp.

The control central processing unit 68 may be programmed with computer software which may be stored in computer memory of the unit 68 and executed by a processor of the unit 68. The control central processing unit 68 may include a computer memory and a computer processor. Computer software of the unit 68 will control the control valves 14, 18, 20, 22, and 56. The control valve 18, 20, 22, and 56 may be biased in a normally closed state, and may be positively opened by one or more control signals from the control central processing unit 68.

Upstream (control valve 14) and Downstream (control valve 56) have on/off control via signals from unit 68, will be provided for internal leak check and system diagnostics.

The computer 100 may be a laptop computer or any other computer. The computer 100 will have a computer program stored in computer memory 110 and executed by computer processor 106 for controlling the apparatus 10 and/or the control central processing unit 68 via ports 69 and 102. The computer 100 will automatically select proper communication port when connected to apparatus 10.

The computer 100 may be used to select a computer program (on computer 100 stored in computer memory 110 running on computer processor 106) for running a start up procedure for control of apparatus 10. As soon as start up is selected, such as by a person or user using computer interactive device 104 the computer processor 106 may perform a check of the apparatus 10 through ports 102 and 69 and using control central processing unit 68. The unit in response to a check request signal or signals by the computer 100 may check the valves 14, 18, 20, 22, and 56, the pressure sensor 64, and the meters 36, 38, and 40. The RTD temperature element, such as RTD 62, in at least one embodiment, will also self check itself from previous internal calibration data to ensure accuracy. The unit 68 may be programmed by a computer program to continuously confirm all flow ranges through each metering tube to ensure proper calibration and accuracy stays within flow specifications pre-established in internal software.

The computer processor 106 is programmed to provide a display of selected parameters on the computer screen, on the computer display screen with graphics showing parameters and flow system in apparatus 10. In at least one embodiment, display does not come on the computer display 108 until all diagnostics, have been checked. The diagnostics may include checking the valves 14, 18, 20, 22 and 56, the pressure sensor 64, the meters 36, 38, and 40. The temperature element RTD (resistance temperature device) 62 is self checked comparing old temperature conditions and actual through computer software, which may be stored in and implemented by control central processing unit 68 or stored in computer memory 110 and implemented or executed by computer processor 106. The meters 36, 38, and 40 are automatically checked with zero flow to ensure accuracy and calibration is maintained as previously mentioned.

Flow rates through meters 36, 38, and 40 may be shown on the computer display 108 by the computer processor 106, as provided by the meters 36, 38 and 40 to the unit 68, and then via the ports 69 and 102 to the computer processor 106 of the computer 100.

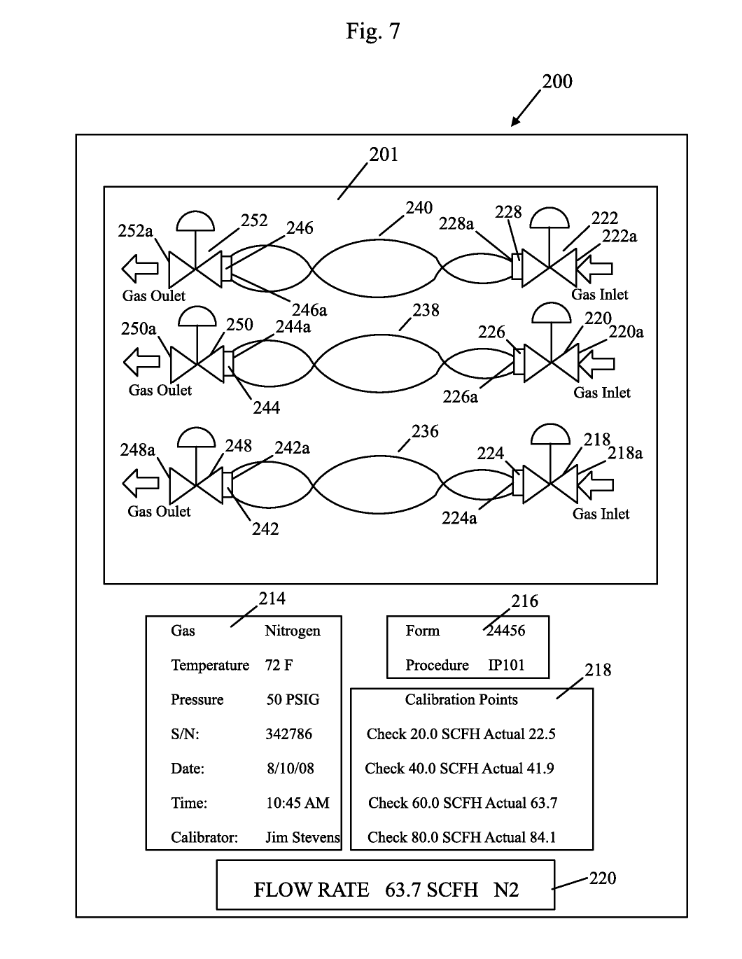

FIG. 7 shows an image 200 which may be displayed on the computer display 108 of the computer 100 of FIG. 6 in accordance with another embodiment of the present invention. The computer processor 106 may implement or execute a computer program stored in computer memory 110 which may cause the image 200 to be displayed on the computer display 108.

The image 200 in FIG. 7 includes sections or fields 201, 214, 216, 218, and 220. Section 201 may be a simplified representation which explains the flow of gas or fluid in the apparatus 10 of FIG. 1. In the simplified representation in section 201, the components 218, 220, 222, 224, 226, 228, 236, 238, 240, 242, 244, 246, 248, 250, and 252 correspond to, and may be similar to or identical to, in form and function to the components 18, 20, 22, 24, 26, 28, 30, 32, 34, 36, 38, 40, 42, 44, 46, 48, 50, and 52, respectively. First, second, and third portions or branches of a gas or fluid may enter input ports 222a, 220a, and 218a and flow through control valves 222, 220, and 218 in section 201 of FIG. 7. The first, second and third portions may flow out 228, 226, and 224, into 240, 238, and 236 respectively. The first, second, and third portions may flow from 240, 238, and 236 to 246, 244, and 242, through ports 246a, 244a, and 242a. The first, second, and third portions may flow from 246, 244, and 242 to and through 252, 250, and 248, respectively. The first, second, and third portions of the gas may next flow out at 252, 250a, and 248a respectively.

In at least one embodiment, the computer processor 106 may select one or more flow paths. For example, in FIG. 7 there is a first flow path including 222a, 222, 228, 240, 246, 252, and 252a, a second flow path including 220a, 220, 226, 238, 244, 250, and 250a, and a third flow path including 218a, 218, 224, 236, 242, 248, and 248a. The computer processor 106 may select the first, second, or third flow paths or some combination of two or three flow paths. The computer processor 106 may be programmed by a computer program stored in computer memory 110 to select one or more flow paths or one or more flow paths may be selected by an operator using computer interactive device 104 of the computer 100. The computer processor 106 may select a flow path by opening a control valve. For example, the computer processor 106 can select the first flow path by opening the control valve 222 (which may represent and may be identical to the control valve 18 shown in FIG. 5) by sending a signal to open the control valve 222 through communications portion 69 and to control processing unit 68, which is then sent by 68 to control valve 22 (or 222) to cause control valve 22 (or 222) to open. Similarly the flow paths with control valves 220 (corresponding to 20) and 222 (corresponding to 22) can be selected by sending a signal or signals from computer processor 106 to control valves 220 (corresponding to 20) or 222 (corresponding to 22) via communications port 69 and control central processing unit 68. The computer processor 106 may cause the computer display 108 to show the selected flow path in the section 201 in image 200 in FIG. 7 in a highlighted form. For example, components 222a, 222, 228, 240, 246, 252, and 252a may be highlighted if the corresponding flow path is selected while the other flow paths may not be highlighted if they have not been selected.

The section 214 shows information about the gas (or liquid) flowing through the apparatus 10 of FIG. 1. In this example, section 214 shows the name of a selected gas or liquid (such as nitrogen), the temperature as “72 F”, the operating pressure as “50 PSIG” (pounds per square inch gauge), the Serial Number as 342786 is the identifying number that each piece of equipment can be identified by. The date the flow is being measured as Aug. 10, 2008, and the calibrator as Jim Stevens. The calibrator or operator of the apparatus 10 and/or computer 100 can then proceed with calibration flow check verification by selecting which screen control and display he has determined his specific application is best suited. For example, the operator or calibrator can select one of the images or screens 200, 300, 400, 501, or 600 shown in FIGS. 7-11.

Section 216 of FIG. 7, generally displays screens that can be changed best suited for operators application referencing cataloged and saved procedures and numbers for different applications based on flow and calibration requirements. Form 24456 can relate to prior calibration procedures and established parameters. All procedures and forms selected by operator have been pre-entered in database and available for operator choice.

Section 218 are selected flow rates given as an example determined by an operator from a pre-determined set of calibration values. For example, an operator can enter into the computer interactive device 104 an expected flow rate, such as 20.0 standard cubic feet per hour for a gas or fluid to be passed through the apparatus 10. After the gas or fluid is passed through the apparatus 10, the computer processor 106 records the actual flow rate, such as in this example 22.5 standard cubic feet per hour. In the same manner, the operator may enter other expected flow rates, such as 40.0, 60.0, and 80.0 standard cubic feet per hour, and the computer processor 106 records the actual flow rates, such as 41.9, 63.7, and 84.1 standard cubic feet per hour as shown in section 218.

Section 220 is the actual flow rate that an operator will view actual flow of a gas or liquid in a real time event.

The operator can choose any one of image or screens 200, 300, 400, 501, or 600 in FIGS. 7-11 respectively. The computer processor 106 may cause the images 200, 300, 400, 501, and 600 to be displayed through use of a Windows (trademarked) based computer program stored in computer memory 110. One of these images 200, 300, 400, 501, or 600 may be selected by an operator entering identifying information into the computer interactive device 104, such as by selection through a Windows (trademarked) based computer program.

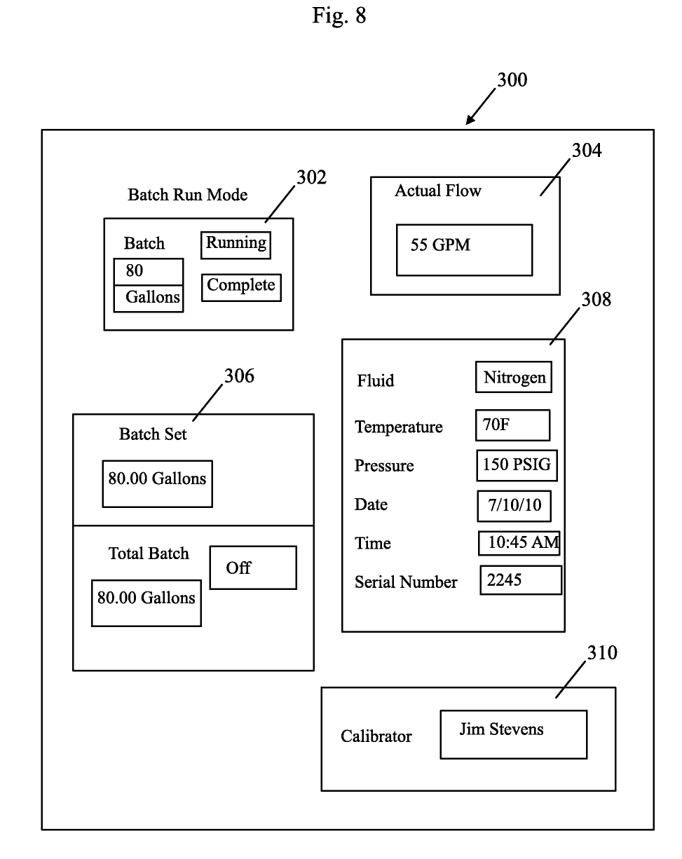

FIG. 8 shows a second image 300 which may displayed on the computer display 108 of the computer 100, of FIG. 6 in accordance with another embodiment of the present invention. The computer processor 106 may implement or execute a computer program stored in computer memory 110 which may cause the image 300 to be displayed on the computer display 108.

The image 300 in FIG. 8 includes sections 302, 204, 306, 308, and 310. The image 300 is displayed when the operator communicates with the interactive device 104 to the CPU 106.

The section 302 in FIG. 8 is identified as “Batch Run Mode” and includes a box or field with a heading of “Batch” and showing how many gallons of gas or fluid has passed through the apparatus 10 from previously determined amount from operator through device 104 to display the image 300. In this example “80” Gallons has passed through apparatus 10 of FIG. 1. The section 302 also includes a “Running” field, indicator, or box and a “Complete” field, indicator, or box. The “Running” field or indicator will light with a bright visable background designating to operator the area is in progress. If the gas or fluid is still in the process of passing through the apparatus 10. The “Complete” field or indicator will light up more visable until the gas or fluid has finished flowing through the apparatus 10.

The section 304 is identified as “Actual Flow” and includes a field or box which shows rate of flow of the fluid through the apparatus 10 while the selected batch amount is running. In this example the actual flow rate is “55 GPM” (GPM: Gallons per minute).

The section 306 has a top half identified of “Batch Set” and a bottom half identification of “Total Batch”. In the top half of section 306, there is a field or box which indicates the number of gallons which are going to be passed through the apparatus 10 in a “batch set” which in this case is “80.00 Gallons”. In the bottom half of the section 306 there is a field or box for the “Total Batch” indicating how many gallons are in the total batch for the fluid or gas to be passed through apparatus 10, which in this example is “80.00 Gallons”. Section 306 is the area where the value of the batch is determined and entered by the operator. The “Off ” display will brighten and become more visable when the batch is complete and operations finished.

The section 308 has designations of “Fluid”, “Temperature”, “Pressure”, “Date”, “Time” and “Serial Number” which related to the fluid or gas currently passing through or which has just passed through the apparatus 10. The section 308 includes fields or boxes next to the various designations to indicate characteristics of the fluid or gas. For example, “Nitrogen”, “70F”, “150 PSIG”, “7/10/10”, and “10:45 AM” are shown across from their corresponding designation to indicate that the gas or fluid is nitrogen, at a temperature of seventy degrees farenheit, at a pressure of one hundred and fifty pounds per square inch gauge, as measured on a date of Jul. 10, 2010, at a time of 10:45 a.m. There serial number “2245” is an example of a number given to a piece of equipment being tested so as to identify and file calibration.

The section 310 shows a name of a “Calibrator” which is the operator or person responsible for operating apparatus 10 and causing the gas or fluid to flow through the apparatus 10. The “Calibrator” is identified as “Jim Stevens” in this example.

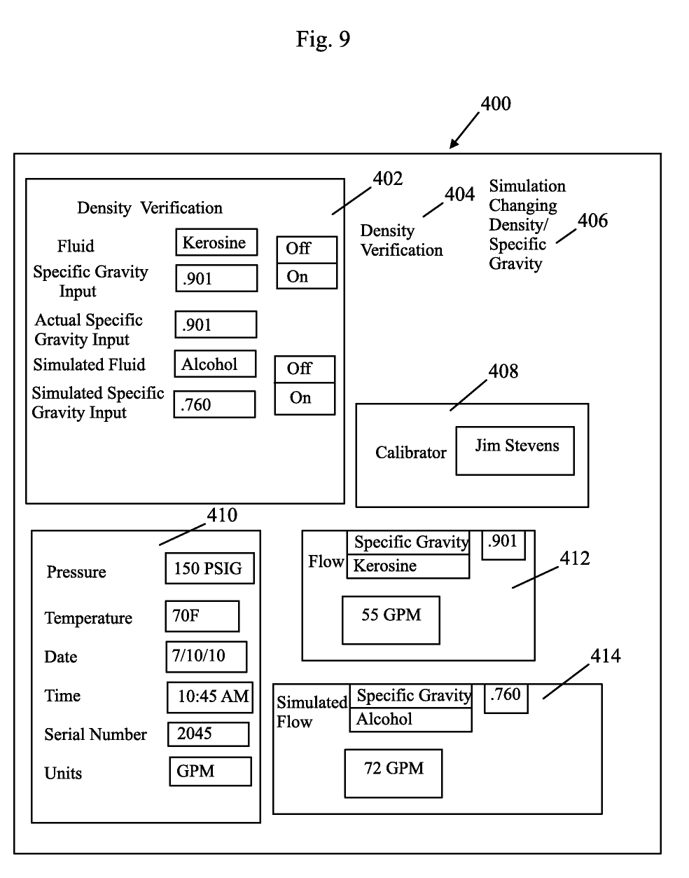

FIG. 9 shows a third image 400 which may displayed on the computer display 108 of the computer 100, of FIG. 6 in accordance with another embodiment of the present invention. The computer processor 106 may implement or execute a computer program stored in computer memory 110 which may cause the image 400 to be displayed on the computer display 108.

The image 400 in FIG. 8 includes sections 402, 404, 406, 408, 410, 412, and 414. The image 400 is displayed when an operator selects the particular screen 400 from the device 104 to call up image 400.

The section 402 includes a designation of “Density Verification”. The section 402 includes a designation of “Fluid” and a corresponding adjacent box indicating the fluid which is passing through apparatus 10, which in this example is “Kerosine”. The section 402 further includes a designation of “Specific Gravity Input” and a corresponding adjacent box indicating the specific gravity (which is this example is 0.901) of the fluid which is entering the apparatus 10, such as entering at input port 12a shown in FIG. 3. The section 402 further includes a designation of “Actual Specific Gravity Input” which may be required for operator to enter if automatic specific gravity calculations cannot find the correct specific gravity. The section 402 further includes a designation of “Simulated Fluid” which means that the can opator can simulate and test other fluids while flowing a different fluid showning in the adjacent box such as “Alcohol”. The section 402 also includes a “Simulated Specific Gravity Input”, which is the specific gravity of the simulated fluid (in this case “alcohol”), which in this example is 0.760. Section 402 also upper “Off” and “On” indicators which indicate which field is selected by operator and lower “Off and “On” indicators which indicate if the “Simulated Fluid” is active.

The section 404 has a designation of “Density Verification” and the section 406 has a designation of “Simulation changing Density/Specific Gravity”. The section 408 shows the “Calibrator” which is the person operating apparatus 10 of FIG. 1, which in this case is “Jim Stevens”.

The section 410 shows “Pressure”, “Temperature”, “Date”, “Time”, “Serial Number”, and “Units” designation and corresponding adjacent boxes with values “150 PSIG”, “70F” (70 degrees Farenheit), “7/10/10”, “10:45 a.m.” , “2045”, and “GPM”, respectively. Section 410 refers to general information of a gas or fluid which is being tested through apparatus 10. The serial no. refers to the identification of the equipment being tested.

The section 412 shows a designation of “Specific Gravity” and a box or indicator of a “0.901” value for the specific gravity of a fluid or gas passing through apparatus 10. Section 412 also indicates the name of the fluid or gas “Kersosine” and the flow rate of the fluid or gas through the apparatus 10 (or more specifically identify component). The flow rate shown in section 412 is 55 GPM (Gallons per minute).

Section 414 includes information similar to the section 412 information, but for the simulated fluid, in this case “Alcohol”. The “Specific Gravity” of “0.760” is shown and the flow rate of “72 GPM” (gallons per minute) is shown in section 414.

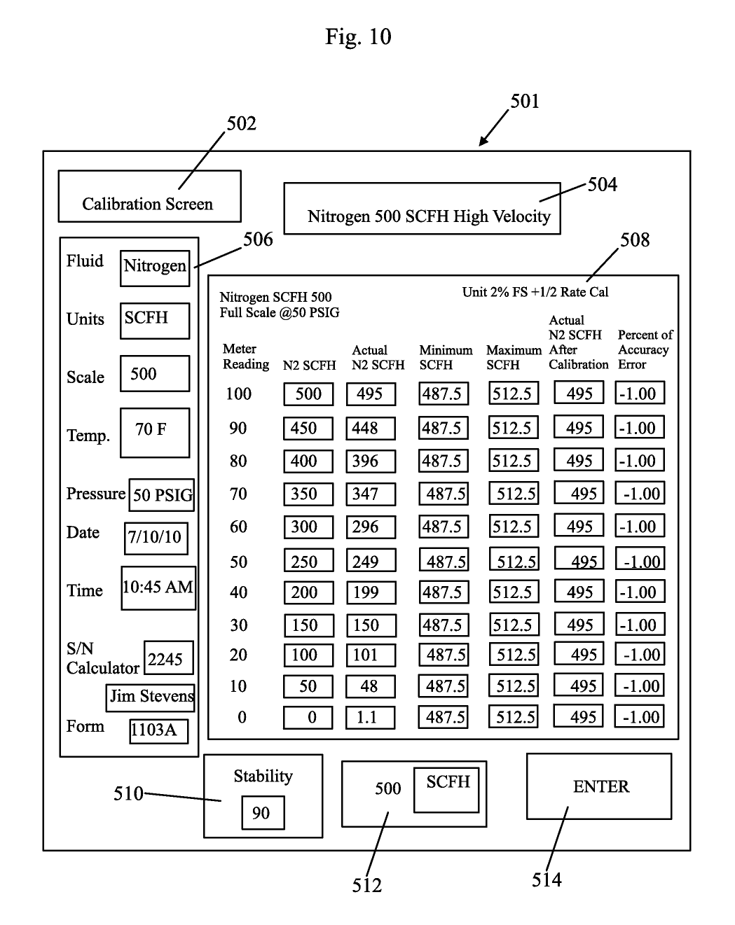

FIG. 10 shows a fourth image 501 which may be displayed on the computer display 108 of the computer 100, of FIG. 6 in accordance with another embodiment of the present invention. The computer processor 106 may implement or execute a computer program stored in computer memory 110 which may cause the image 501 to be displayed on the computer display 108.

The image 501 includes sections 502, 504, 506, 508, 510, 512, and 514. The image 501 is displayed when an operator enters certain information into computer interactive device 104 to call up the image 501.

The section 502 indicates that the image 502 refers to a “Calibration Screen”. The section 504 indicates that the fluid or gas passing through the apparatus 10 is “Nitrogen 500 SCFH High Velocity” which means Nitrogen flowing through at 500 Standard Cubic Feet per Hour—which is a high velocity flow rate full scale based on established parameters. Section 506 provides characteristics of the fluid or gas flowing through apparatus 10. Section 506 includes designations for “Fluid”, “Units”, “Scale”, “Temp.”, “Pressure”, “Date”, “Time”, “S/N Calculator” and “Form” and values in corresponding adjacent fields or boxes of “Nitrogen”, “SCFH” (standard cubic feet per hour), “500”, “70 F” (seventy degrees farenheit), “50 PSIG”, “7/10/10”, “10:45 AM”, “2245”, and “1103A respectively. The name of Jim Stevens is shown in a box or field in section 506 as the operator of the apparatus 10 measuring the flow of the fluid or gas indentified in section 506. The form “1103 A” is an example of a calibration procedure chosen by the operator. The serial number designates the equipment that is being calibrated and tested.

The section 508 includes a designation of “Nitrogen SCFH 500 Full Scale @50 PSIG” which identifies the fluid or gas as Nitrogen flowing at 500 standard cubic feet per hour full scale maximum flow at fifty pounds per square inch gauge. The section 508 further shows a table of various data points to be tested on equipment verifying flow and accuracy at each point. For example, at a meter reading of “100” “N2 SCFH” (Nitrogen: N₂, SCFH: standard cubic feet per hour) would be 500 SCFH “Actual N2 SCFH” is what the equipment is flowing that is being tested. “Minimum SCFH” is the minimum allowed flow that the equipment can be at or above to pass acceptable calibration and stay within specification through each test point. “Maximum SCFH” is the maximum allowed flow that the equipment can be at or below to pass acceptable calibration and stay within specification through each test point. “Actual N2 SCFH after calibration is the final value entered after any correction or adjustment is performed on tested equipment. “Percent of Accuracy Error” which is based on the difference between actual fluid flow rate and desired flow rate. The values shown in the first row, corresponding to a “100” Meter Reading are “500”, “495”, “487.5”, “512.5”, “495”, and “−1.00”. The computer processor 106 is programmed by a computer program which may be stored in computer memory 110, to calculate a row of values corresponding to the heading designations shown for each of meter readings, “100”, “90”, “80”, “70”, “60”, “50”, “40”, “30”, “20”, “10”, and “0” in section 508.

The section 510 includes a designation of “Stability” and a field or box indicating “90” which means how stable the flow rate is within apparatus 10. When the stability reading drops below 1 the flow rate can be entered as a final number. The section 512 includes a designation of “500” and a field or box indicating “SCFH” which indicates that the fluid or gas has an anticipated flow rate of 500 standard cubic feet per hour maximum through the apparatus 10. The section 514 has indication of “Enter” and when selected by an operator using computer interactive device 104, the data running will be entered in proper field once stability of flow is achieved.

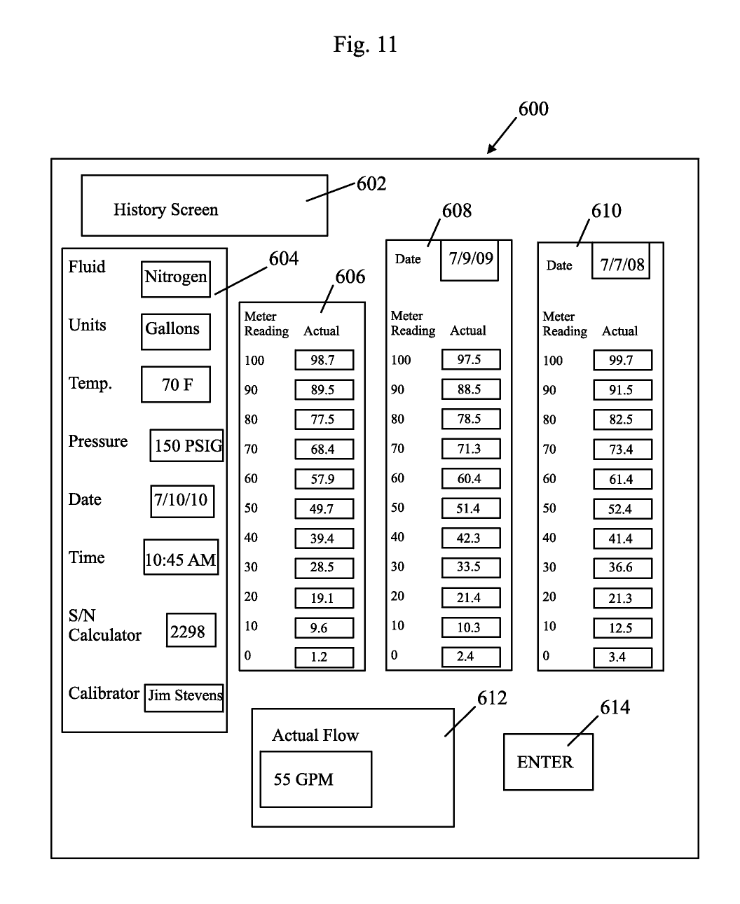

FIG. 11 shows a fifth image 600 which may be displayed which may be displayed on the computer display 108 of the computer 100, of FIG. 6 in accordance with another embodiment of the present invention. The computer processor 106 may implement or execute a computer program stored in computer memory 110 which may cause the image 600 to be displayed on the computer display 108.

The image 600 includes sections 602, 604, 606, 608, 610, 612, and 614. The image 600 is displayed when an operator enters certain information into computer interactive device 104 to call up the image 600.

The section 602 includes a designation of “History Screen” to indicate that this refers to a history screen of previous calibration and testing of specific equipment.

The section 604 shows the designations “Fluid”, “Units”, “Temp.”, “Pressure”, “Date”, “Time”, “S/N Calculator” and “Calibrator” and values in corresponding adjacent fields or boxes of “Nitrogen”, “Gallons”, “70 F” (seventy degrees Fahrenheit), “150 PSIG”, “7/10/10”, “10:45 AM”, “2298”, and “Jim Stevens”, respectively. The section 604 information deals with a fluid or gas which has previously flowed through the apparatus 10.

The section 606 shows a table of meter readings during testing anticipated and actual meter readings in a box adjacent in the same row as the anticipated meter reading. In section 606, there are anticipated meter readings of “100”, “90”, “80”, “70”, “60”, “50”, “40”, “30”, “20”, “10”, and “0”, and corresponding actual meter readings of “98.7”, “89.5”, “77.5”, “68.4”, “57.9”, “49.7”, “39.4”, “28.5”, “19.1”, “9.6”, and “1.2” flow specifications. The section 606 is for calibration and to compare previous calibrations from prior date.

The section 608 shows a table of meter readings from a previous calibration done on Jul. 9, 2009 displaying desired and actual meter readings in a box adjacent to each other for identified meter number 2298. In section 608, there are anticipated meter readings of “100”, “90”, “80”, “70”, “60”, “50”, “40”, “30”, “20”, “10”, and “0”, and corresponding actual meter readings of “97.5”, “88.5”, “78.5”, “71.3”, “60.4”, “51.4”, “42.3”, “33.5”, “21.4”, “10.3”, and “2.4”, actual flow data recorded.

The section 610 shows a table of meter readings from a previous calibration done on Jul. 7, 2008 displaying desired and actual meter readings in a box adjacent to each other for identified meter number 2298. In section 608, there are anticipated meter readings of “100”, “90”, “80”, “70”, “60”, “50”, “40”, “30”, “20”, “10”, and “0”, and corresponding actual meter readings “99.7”, “91.5”, “82.5”, “73.4”, “61.4”, “52.4”, “41.4”, “36.6”, “21.3”, “12.5”, and “3.4”, actual flow data recorded. The section 612 shows the actual flow of the fluid to be viewed during calibration and testing. (in this example Nitrogen) as “55 GPM” (gallons per minute). The section 614 shows an enter button or field which can be selected by an operator of apparatus 10 by using interactive device 104 to select flow rate to be entered in data chart above in FIG. 11.

The computer memory 110 of the computer 100 may include computer files and programmed default settings that are customized for controlling the central processing unit 68 through communications port 68 and thereby controlling the valves 14, 18, 20, 22, and 56, using flow meter readings from meters 36, 38, and 40.

The section 214 shown in FIG. 7 may include various information about fluid types and operating conditions in process. The fluid flow rate such as measured by FIG. 7, section 220 by meters 36, 38 and 40, in at least one embodiment, provide a signal or signals to control central processing unit 68 to indicate flow rate of a fluid through the particular component. The user can program a desired flow rate through the computer processor 106 by entering a flow rate through computer interactive device 104, by using a computer mouse and/or keyboard of device 104, into computer 100. For example the flow rate through meter 36, 38 or 40 can be controlled by data into computer 100, which causes computer processor 106 to send a signal or signals to control central processing unit 68 through port 69 to control flow of a fluid through control valve 18, 20 or 22.

A temperature measurement device, such as RTD 62, may be provided, which may provide the temperature of a gas flowing through a particular component to the control central processing unit 68. The computer 100 may be programmed to use temperature information provided by the control central processing unit 68 from the RTD 62 to compensate flow rate on the display screen chosen.

Signals indicating pressures at inlets and/or outlets are provided to the control central processing unit 68 and thereafter to the computer 100 (and computer processor 106) via communications port 69. The computer memory 110 may include computer software which may be executed by computer processor 106 which may determine inlet flow rate at the input 12a and which may modify the flow rate to produce a compensated, modified, or changed flow rate at output port 57b. I.e. for example, nitrogen my come into the apparatus 10 at input port 12a at a flow rate of 500 standard cubic feet per hour and may have its flow rate determined by computer processor 106 by use of meters 36, 38 and/or 40 and may have its flow rate modified by the computer processor 106 controlling control valves 18, 20, and/or 22 and/or 48, 50 and 52 to produce a modified flow rate of 515 standard cubic feet per hour. The modified rate can be determined by the operator inputting information into computer interactive device 104 to provide data to computer processor 106 for controlling valves 18, 20 and 22.

The image 200 may include a list of selected flow units. Examples that are offered could be a choice of fluids such as Nitrogen, Hydrogen, Argon, Helium, Methane, Water, Alcohol, #2 Fuel Oil, #6 Fuel Oil. The full list will offer almost all fluids that are known in use being controlled or measured. The operator may enter into the computer processor 106 or into the computer memory 110 or select flow units using the computer interactive device 104 for display on the image 200. The operator may enter fluid type into the into the computer processor 106 or into the computer memory 110 or select fluid or gas type using the computer interactive device 104 for display on the image 200.

Almost all fluids (including liquids or gasses) can be tested by the apparatus 10. Liquids and gasses can be tested with a high accuracy of +/−0.5% or better. The apparatus 10 will be calibrated to NIST (National Institute of Standards and Technology) standards and at least in one embodiment, will have traceability back to NIST. A standard display feature during operation will show flow screen section 220 startup at the time the flow becomes stable the flow screen section 220 will show a green background indicating to the operator that the reading can be recorded. In at least one embodiment, a number percent will appear such as in FIG. 10 to show stability to operator so that he or she can see when flow approaches stabilization. The date and time information shown in each of images 200, 300, 400, 501, and 600 may be shown to operator as a default feature.

Alternate choice data screens with the ability to upload calibration forms and actual certifications may be provided. FIG. 10 shows an example of certification data numbers that an operator can retrieve using the computer 100 implementing computer software stored in the computer memory 110. FIG. 11 shows a calibration screen but also previously done calibrations done on the same piece of equipment from previous years. Previous years data that can be viewed FIG. 11 (608, 6100) gives the operator the ability to review easily all data to determine if the equipment being tested needs service or replacement before the equipment fails fully.

The communications port 69 may be connected to the computer 100 through an internet connection. Through such an internet connection, such as through (Cal connect) the apparatus 10 can transmit data to be stored at a company for review and any calibration audit a customer may need to do.

Operator can view history on S/N (serial number), equipment type or information of equipment previously checked by logging on to IP (Internet Protocol) calibration secured data website.

The computer 100 may run a Microsoft (trademarked) windows (trademarked) based program to view data simultaneously a multiple of fields.

An excel (trademarked) computer program stored in computer memory of computer 100, may be used to provide excel based calibration forms, such as similar to FIG. 10, that can be interfaced on the computer 100 with actual flow to be added into proper columns as testing is being done. For data acquisition and storage:

(a) The communications port 69 may include two USB (Universal Serial Bus) ports in at least one embodiment for data transferring to a laptop computer. An extra port can be supplied so remote access can be used via the internet for any diagnostic situation requiring a technician or operator to simultaneously review data with local laptop computer.

(b) A lockout feature may be installed in computer software stored in the control central processing unit 68 to prevent copying or tampering from outside sources.

The control central processing unit 68 may include computer memory having computer software stored therein.

For internal communications: A computer software program on the computer 100 to receive raw data (electronic signal) from the central processing CPU 68 which receives signal from meters 36, 38, 40 pressure sensor 64 and temperature sensor 62 and then internally translates using special signal conditioning diagnostic parameters and formulas to achieve proper flow. Computer software, in at least one embodiment may have special capabilities to determine and redirect flow paths through each meter 36, 38, 40 and flow streams may be controlled by valves 18, 20, 22. In at least one embodiment, density check is calculated through internal software, such as internal computer software in control central processing unit 68, establishing what fluid is in apparatus 10 based on scientific formulas previously entered from established known values known in science.

Flow tube selection is performed from meter readings 36, 38, 40 transmitting data to control central processing unit 68 where internal computer software residing in control central processing unit 68 and implemented by control central processing unit 68 determines based on predetermined entries from an operator, which may be input into control central processing unit 68 through communications port 69, such as from computer processor 106, or provided by a company which flow stream may, in some embodiments, produce optimum accuracy and reading. In one or more embodiments, the control central processing unit 68 will send a control voltage to direct the flow through the control valves 18, 20, 22. This operation is performed automatically by the control central processing unit 68 as programmed by computer software residing on the control central processing unit 68 and without any operator requirement or knowledge, giving the operator a real advantage to avoid any errors or problems. (such as over running any meter).

Pressure transmitters, such as pressure sensor 64 in FIG. 3 are self calibrating and will automatically adjust after initial startup. Pressure signals from the pressure sensor 64 to the control central processing unit 68 will help determine based on preset computer software in control central processing unit 68 which flow stream will provide best path with lowest pressure drop helping operator and process.

An example or redirection of flows is, fluid flows through meter 36, but as the flow rate being measured, increases beyond pre-established presets, from computer software stored in control central processing unit 68, valve 20 will receive signal from control central processing unit 68 which will cause the valve 20 to begin opening to redirect flow. The control central processing unit 68 will also send signals to valve 18 to cause the valve 18 to begin closing until the valve 18 is fully closed and the valve 20 is opened fully and flow is within parameters preset by the control central processing unit 68.

If an extra flow range beyond full range of highest flow meter 40 is required, operator can by initially entering required flow in a screen such as in section 220 (flow rate 63.7 SCFH N2) by using the computer interactive device 104 image 200 shown in FIG. 7. Once flow is entered, the control central processing unit 68 will transmit signals to open multiple valves of the valves 18, 20, and 22 and accommodate higher requested flow.

Internal calibration is saved in a hidden lockout computer files within the control central processing unit 68 that can be accessed only by a company operator having proper security codes during calibration of apparatus 10 only.

Each of meters 36, 38, and 40 may be a coriolis flow meter. The three Coriolis tubes for the three meters 36, 38, and 40 are internally mounted and manifolded together as shown in FIG. 1 for establishing a very large flow range of 2000-1. (example is standard flow range is 10-1 turndown such as reading 1-100 gallons/per hour where the apparatus 10 will flow 2000-1 allowing 1-2000 gallons/per hour) Flowing three tubes internally surpasses existing equipment and excels higher when all can be combined together to achieve a much higher rate. Apparatus 10 has self diagnostic capabilities to ensure all operations within the system are operating at highest accuracy requirement. Pressure and temperature and compensation and readings are provided within NIST specifications.

The program has adapted a very user friendly software program enabling the operator ease of operation and secure with all possible flow readings that the equipment can provide.

Operator can use software program to view previous test results numerically and graphically on specific equipment within facility compared to current flow temp and pressure. This gives a huge advantage to be pro active on equipment that may be failing or needs maintenance avoiding costly delays or process failures.

Almost all fluids can be tested on both liquids or gases, with high accuracy of NIST (National Institute of Standards and Technology) Traceability of +/−0.5% or better. The ability to test on all fluids without changing equipment gives operator an advantage of keeping less equipment at his facility doing a very unique application.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus for controlling the flow of fluids such as liquids or gasses comprising:
an input control valve having an input port for receiving a fluid and an output port;
an input manifold having an input port and first and second output ports, the input port of the input manifold connected to the output port of the input control valve;
a first further control valve having an input port and an output port, the input port of the first further control valve connected to the first output port of the input manifold;
a second further control valve having an input port and an output port, the input port of the second further control valve connected to the second output port of the input manifold;
a first flow meter having an input port and an output port, the input port of the first flow meter connected to the output port of the second further control valve;
a second flow meter having an input port and an output port, the input port of the first flow meter connected to the output port of the second further control valve;
a first check valve having an input port and an output port, the input port of the first check valve connected to the output port of the first flow meter;
a second check valve having an input port and an output port, the input port of the second check valve connected to the output port of the second flow meter;
an output manifold having first and second input ports and an output port, the first input port of the output manifold connected to the output port of the first flow meter, the second input port of the output manifold connected to the output port of the second flow meter;
an output control valve having an input port and an output port, the input port of the output control valve connected to the output port of the output manifold;
a control central processing unit which controls the input control valve, the first further control valve, the second further control valve, the output control valve;
and wherein the control central processing unit is configured to be in communication with the first flow meter and the second flow meter, such that the control central processing unit receives one or more signals concerning fluid flow through the first flow meter and the second flow meter.

2. The apparatus of claim 1 wherein
the input manifold has a third output port;
and further comprising
a third further control valve having an input port and an output port, the input port of the third further control valve connected to the third output port of the input manifold;
a third flow meter having an input port and an output port, the input port of the third flow meter connected to the output port of the third further control valve;
a third check valve having an input port and an output port, the input port of the third check valve connected to the output port of the third flow meter;
and wherein the output manifold has a third input port, the third input port of the output manifold connected to the output port of the third flow meter;
wherein the control central processing unit controls the third further control valve; and wherein the control central processing unit is configured to be in communication with the third flow meter, such that the control central processing unit receives one or more signals concerning fluid flow through the third flow meter.

3. The apparatus of claim 1 wherein
the first flow meter is a coriolis flow meter; and
the second flow meter is a coriolis flow meter.

4. The apparatus of claim 2 wherein
the first flow meter is a coriolis flow meter;
the second flow meter is a coriolis flow meter; and
the third flow meter is a coriolis flow meter.

5. The apparatus of claim 1 further comprising
a computer display;
a computer interactive device;
a computer memory;
a computer processor; and
wherein the computer memory has stored therein a computer program which is executed by the computer processor in communication with the control central processing unit to cause information about the flow of fluid through the first flow meter and the second flow meter to be displayed on the computer display;
wherein the computer memory has stored therein a computer program which is executed by the computer processor in communication with the control central processing unit to receive commands from an operator via the computer interactive device to control the input control valve, the first further control valve, the second further control valve, and the output control valve.

6. The apparatus of claim 1 further comprising
a sealed and waterproof enclosure;
wherein the input control valve, the input manifold, the first further control valve, the second further control valve, the first flow meter, the second flow meter, the first check valve, the second check valve, the output manifold, and the output control valve are located within the sealed and waterproof enclosure.

7. The apparatus of claim 1 wherein
the apparatus is portable.

8. The apparatus of claim 1 further comprising
a computer display;
a computer interactive device;
a computer memory;
a computer processor; and
wherein the computer memory has stored therein a computer program which is executed by the computer processor in communication with the control central processing unit to automatically control the input control valve, the first further control valve, the second further control valve, and the output control valve.

9. The apparatus of claim 1 further comprising
a computer display;
a computer interactive device;
a computer memory;
a computer processor; and
wherein the computer memory has stored therein a computer program which is executed by the computer processor in communication with the control central processing unit to automatically control the input control valve, the first further control valve, the second further control valve, the third further control valve, and the output control valve.

10. The apparatus of claim 8 wherein
the computer program automatically controls the input control valve, the first further control valve, the second further control valve, and the output control valve based on information received by the computer processor from the first flow meter, and the second flow meter.

11. The apparatus of claim 9 wherein
the computer program automatically controls the input control valve, the first further control valve, the second further control valve, the third further control valve, and the output control valve based on information received by the computer processor from the first flow meter, the second flow meter, and the third flow meter.

12. The apparatus of claim 1 wherein
the first flow meter, the second flow meter, and the third flow meter are fixed and mounted to a support plate.

13. The apparatus of claim 12 wherein
the first flow meter, the second flow meter, and the third flow meter are fixed and mounted to the support plate so that the first flow meter is substantially parallel to the second and the third flow meters.

14. The apparatus of claim 8 wherein
the computer program runs a self diagnostic program which automatically controls the input control valve, the first further control valve, the second further control valve, and the output control valve, and which examines one or more readings from the first flow meter and the second flow meter responsive to the automatic control of the input control valve, the first further control valve, the second further control valve, and the output control valve, to determine if the apparatus is operating properly and which displays information on the computer display to indicate if the apparatus is operating properly.

15. A method of controlling flow of a fluid such as a liquid or gas comprising
passing the fluid through a first flow meter to determine a first flow rate;
determining if the first flow rate is within a specified range of a first desired flow rate; and
using a computer processor to close a first valve so that the fluid is no longer passed through the first flow meter if the first flow rate is not within the specified range of the first desired flow rate; and
using the computer processor to open a second valve so that the fluid can flow through a second flow meter.

16. A method comprising
sending a first signal to a computer processor to indicate a first current flow rate of a first fluid through a first flow meter;
changing the first current flow rate of the first fluid through the first flow meter to a first new flow rate of the first fluid through the first flow meter by using the computer processor to control a first valve in response to the first signal;
sending a second signal to the computer processor to indicate a second current flow rate of a second fluid through a second flow meter; and
changing the second current flow rate of the second fluid through the second flow meter to a second new flow rate of the second fluid through the second flow meter by using the computer processor to control a second valve in response to the second signal.

17. The method of claim 16 further comprising
sending a third signal to the computer processor to indicate a third current flow rate of a third fluid through a third flow meter; and
changing the third current flow rate of the third fluid through the third flow meter to a third new flow rate of the third fluid through the third flow meter by using the computer processor to control a third valve in response to the third signal.

18. The method of claim 16 further comprising
measuring a first temperature of the first fluid while it is flowing through the first flow meter at the first current flow rate; and
wherein the first new flow rate is set by the computer processor based on the first temperature.

19. The method of claim 16 further comprising
measuring a first temperature of the first fluid while it is flowing through the first flow meter at the first current flow rate, wherein the first new flow rate is set by the computer processor based on the first temperature; and
measuring a second temperature of the second fluid while it is flowing through the second flow meter at the second current flow rate, wherein the second new flow rate is set by the computer processor based on the second temperature.
